(19) United States
(12) Patent Application Publication
(10) Pub. No.: US 2013/0338294 A1
(43) Pub. Date: Dec. 19, 2013

(54) INFLATION-GAS-TIGHT LAYER INCLUDING A METAL OXIDE AS A CROSS-LINKING AGENT

(71) Applicants: Aline Riou, Clermont-Ferrand Cedex 9 (FR); Séverine Bizet, Clermont-Ferrand Cedex 9 (FR)

(72) Inventors: Aline Riou, Clermont-Ferrand Cedex 9 (FR); Séverine Bizet, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/992,282

(22) PCT Filed: Dec. 9, 2011
(86) PCT No.: PCT/EP2011/072295

§ 371 Date: Aug. 29, 2013

(30) Foreign Application Priority Data
Dec. 22, 2010 (FR) 1061023

(51) Int. Cl. C08L 23/28; C08K 3/04; C08K 3/36; C08K 3/34

(52) U.S. Cl. CPC C08L 23/283; C08K 3/346; C08K 3/04; C08K 3/36
USPC 524/447; 524/576; 524/502

(57) ABSTRACT

A layer that is airtight to inflation gases is formed of a composition that includes at least: a halogenated elastomer having a content of greater than or equal to 70 parts by weight per hundred parts by weight of elastomer (phr); a reinforcing filler; and a crosslinking system based on a metal oxide. The crosslinking system contains less than 0.5 phr of sulphur and may be free of sulphur. More particularly, the crosslinking system contains less than 0.1 phr of sulphur.

The field of the present invention is that of pneumatic objects (or inflatable articles) provided with an elastomer layer that is airtight to the inflation gases.

Today, the layer that is airtight to the inflation gases of pneumatic objects generally includes a conventional vulcanization system combining sulphur and a vulcanization accelerator. However, it is known that such a system is detrimental to the use of the uncured composition via the scorching phenomenon. It is recalled that the “scorching” phenomenon rapidly leads, during the preparation of rubber compositions in an internal mixer, to premature vulcanizations (“scorching”), to very high viscosities in the uncured state, and ultimately to rubber compositions that are virtually impossible to work and to process industrially. Consequently, it would be advantageous for the manufacturers to obtain compositions having a scorch time greater than the compositions currently used.

Furthermore, the sulphur vulcanization of the airtight layers enables a co-vulcanization with the adjacent layer, which leads to very good adhesion between these layers. This adhesion is also important so that these layers do not delaminate during use.

At present, and unexpectedly, the applicant has found a layer of pneumatic object airtight to inflation gases, the elastomer composition of which can be crosslinked under the sole effect of a metal oxide, i.e., in the absence of sulphur as a vulcanizing agent. The scorch time of these compositions is substantially prolonged with respect to that of a composition comprising a sulphur vulcanization system. Furthermore, it has surprisingly been shown that the layer crosslinked with a metal oxide can adhere satisfactorily to a layer vulcanized conventionally with sulphur, enabling these compositions to be used in tyres consisting of layers vulcanized with sulphur and layers crosslinked using a metal oxide.

Thus, the invention relates to a layer airtight to inflation gases, the composition of which is based on at least a halogenated elastomer, having a content of greater than or equal to 70 parts by weight per hundred parts by weight of elastomer (phr), a reinforcing filler and a crosslinking system based on a metal oxide, characterized in that said crosslinking system is free of sulphur or contains less than 0.5 phr, and more particularly less than 0.1 phr, thereof.

The airtight layer of the invention makes it possible to facilitate the working of the rubber compound in the uncured state owing to the increase in the scorch time of the composition.

Preferably, the invention relates to a layer airtight to inflation gases as defined above in which the halogenated elastomer is selected from halogenated butyl rubbers such as brominated butyl rubber.

Also preferably, the invention relates to a layer airtight to inflation gases as defined above in which the content of the halogenated elastomer is greater than or equal to 85 phr. Preferably, the content of the halogenated elastomer is 100 phr.

Preferably, the invention relates to a layer airtight to inflation gases as defined above in which the metal oxide is selected from the oxides of metals from group II, IV, V, VI, VII or VIII or a mixture of these metal oxides. More preferably, the metal oxide is zinc oxide. In particular, the invention relates to a layer airtight to inflation gases as defined above in which the content of metal oxide is within a range varying from 2 to 25 phr.

Preferably, the invention relates to a layer airtight to inflation gases as defined above in which the reinforcing filler is carbon black and/or silica. Preferably, the content of reinforcing filler is within a range varying from 30 to 90 phr, preferably from 35 to 70 phr.

According to one preferred embodiment, the invention relates to a layer airtight to inflation gases as defined above that also comprises an inert filler. Preferably, the inert filler is selected from chalk, graphite, glass flakes or platy fillers based on silicon such as smectites, kaolin, talc, mica, montmorillonites and vermiculite, or a mixture of the latter. Preferably, the content of the inert filler is within a range varying from 2 to 35 phr.

Preferably, the invention relates to a layer airtight to inflation gases as defined above that also comprises a plasticizing system. Preferably, the plasticizing system is selected from hydrocarbon-based resins, the glass transition temperature of which is above 20° C. and the softening point of which is below 170° C., or from polyisobutylene oils having a number-average molecular weight (Mn) between 200 g/mol and 40 000 g/mol, or from mixtures of these oils and/or resins. Preferably, the content of plasticizer is within a range varying from 2 to 50 phr, preferably from 5 to 25 phr.

According to one preferred embodiment, the invention relates to a layer airtight to inflation gases as defined above in which the crosslinking system is free of sulphur.

Alternatively, the invention relates to a pneumatic object provided with a layer airtight to inflation gases as defined above.

The invention also relates to a tyre provided with a layer airtight to inflation gases as defined above.

### I—DESCRIPTION OF THE INVENTION

The subject of the invention therefore relates to a layer airtight to inflation gases, which can be used for manufacturing tyres, the composition of which is based on at least a halogenated elastomer, having a content of greater than or equal to 70 parts by weight per hundred parts by weight of elastomer (phr), a reinforcing filler and a crosslinking system based on a metal oxide, characterized in that said crosslinking system is free of sulphur or contains less than 0.5 phr, and more particularly less than 0.1 phr, thereof.

The expression “composition based on” should be understood to mean a composition comprising the in situ mixture and/or reaction product of the various base constituents used, some of these constituents being able to, and/or intended to react together, at least partially, during the various phases of manufacturing the composition, or during the subsequent curing, modifying the composition such as it is prepared at the start. Thus, the compositions as employed for the invention may be different in the uncrosslinked state and in the crosslinked state.

In an equivalent manner, the invention preferably relates to a composition as defined above, in which the composition is in the uncrosslinked state or in the crosslinked state.

The airtight layer of the invention comprises two walls, which may define three domains: two “edge domains” ranging from the wall to around 20% of the thickness of the layer, towards the inside of said airtight layer, and one “central domain” between these two edge domains. Thus, the expression “central domain” should be understood to mean “in the inner part of the layer located at more than 20% from its edges”.

In the present description, unless expressly indicated otherwise, all the percentages (%) indicated are percentages by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

### I-1 Elastomer or Rubber

Usually, the terms “elastomer” and “rubber”, which are interchangeable, are used without distinction in the text.

### I-1-a Halogenated Elastomers

For the purposes of the present invention, the expression “halogenated elastomer” should be understood to mean an elastomer having a chain that is modified so as to substitute certain hydrogen atoms with halogen atoms. The halogen atom may in particular be selected preferably from chlorine or bromine.

For example, the elastomer may be selected from the family of butyl rubbers, the corresponding halogenated elastomer being a halobutyl. Mention will be made, as examples of halobutyl rubber that are particularly suitable for carrying out the invention, of: chlorobutyl rubbers such as the chloroisobutylene-isoprene copolymer (CIIR) and bromobutyl rubbers such as the bromoisobutylene-isoprene copolymer (BIIR) and among the latter, mention may be made, as an example of branched butyls, of halogenated star-branched butyls such as “Star-branched Bromobutyl 6222” sold by Exxon.

In the airtight layer according to the invention, it is important that the content of halogenated elastomer is at least equal to 70 phr in order for the crosslinking with metal oxides to be effective. Preferably, the content of halogenated elastomer is greater than or equal to 80 phr, more preferably greater than 85 phr, more particularly greater than 90 phr and preferably greater than 95 phr. For example, and also preferably, this content may be 100 phr.

### I-1-b Other Elastomers of the Composition

When the rubber composition comprises a content of halogenated elastomer of less than 100 phr, the elastomeric matrix of the composition is then a blend of halogenated elastomer(s) with at least one (that is to say one or more) non-halogenated elastomer. In other words, the composition may contain a content of non-halogenated elastomer within a range varying from 0 to 30 phr, preferably from 1 to 20 phr, more preferably from 5 to 15 phr, for example 10 phr.

For example, these elastomers are selected from all non-halogenated elastomers and these elastomers may be saturated or unsaturated, natural or synthetic. They may in particular be selected from the group consisting of butyl rubbers, essentially unsaturated diene elastomers, essentially saturated diene elastomers and mixtures of these elastomers. For example, it could be an elastomer selected from the group consisting of natural rubber (NR), synthetic polyisoprenes (IR), butyl rubber (IIR or polyisobutylene), polybutadienes (abbreviated to “BR”), butadiene copolymers, isoprene copolymers, butadiene-styrene copolymers (SBR), isoprene-butadiene copolymers (BIR), isoprene-styrene copolymers (SIR) and isoprene-butadiene-styrene copolymers (SBIR) and mixtures of these elastomers.

I-2 Reinforcing filler

Use may be made of any type of reinforcing filler known for its capabilities of reinforcing a rubber composition which can be used for the manufacture of tyres, for example an organic filler, such as carbon black, a reinforcing inorganic filler, such as silica, or else a blend of these two types of filler, in particular a blend of carbon black and silica.

All carbon blacks are suitable, in particular blacks of the HAF, ISAF or SAF type conventionally used in tyres (“tyre-grade” blacks). Among the latter, mention will more particularly be made of reinforcing carbon blacks such as blacks of the 100 or 200 series (grades ASTM), such as, for example, the N115, N134, N220 or N234 blacks, or else, depending on the applications targeted, the blacks of higher series from 300 to 900 (for example N326, N330, N339, N347, N375, N550, N650, N660, N683, N772 or N990). The carbon blacks could, for example, already be incorporated into the elastomer in the form of a masterbatch (see, for example, Applications WO 97/36724 or WO 99/16600).

Mention may be made, as examples of organic fillers other than carbon blacks, of the functionalized polyvinylaromatic organic fillers as described in Applications WO-A-2006/069792 and WO-A-2006/069793.

The term “reinforcing inorganic filler” should be understood, in the present patent application, by definition, as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of microbeads, of granules, of beads or any other appropriate densified form. Of course, the expression “reinforcing inorganic filler” is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica having a BET surface area and a CTAB specific surface area both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface area as described in Application WO 03/16837.

When silica is present in the composition, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “unsymmetrical” depending on their specific structure, as described, for example, in Applications WO 03/002648 (or US 2005/016651) and WO 03/002649 (or US 2005/016650).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H_{S}O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, as described in Patent Application WO 02/083782 (or US 2004/132880).

Mention will in particular be made, as coupling agent other than alkoxysilane polysulphide, of bifunctional POSs (polyorganosiloxanes) or else of hydroxysilane polysulphides (R2=OH in the above formula III), such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

When the rubber compositions in accordance with the invention contain coupling agents, in a known manner, their content is adjusted depending on the silica content, it is preferably within a range extending from 0.1 to 10 phr, more preferably from 0.2 to 8 phr and more preferably still from 0.5 to 5 phr.

A person skilled in the art understands that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

A person skilled in the art knows how to adapt the total content of total reinforcing filler (carbon black and reinforcing inorganic filler such as silica) as a function, on the one hand, of the specific surface area of the reinforcing filler and, on the other hand, depending on the particular applications targeted. Specifically, the optimum being, in a known way, different depending on the particular applications targeted: the level of reinforcement expected with regard to a bicycle tyre, for example, is of course less than that required with regard to a tyre capable of running at high speed in a sustained manner, for example a motorcycle tyre, a tyre for a passenger vehicle or a tyre for a utility vehicle, such as a heavy vehicle. Preferably, this content is within a range extending from 30 to 90 phr, preferably from 30 to 80 phr, more preferably from 35 to 70 phr. According to one particular embodiment, the reinforcing filler contains predominantly, by weight, carbon black, that is to say that it represents the highest content in phr among the reinforcing fillers of the composition, preferably the carbon black represents more than 50% of the reinforcing filler, for example at a content within a range varying from 30 to 90 phr, preferably from 30 to 80 phr, more preferably from 35 to 70 phr.

### I-3 Inert or Non-Reinforcing Fillers

Optionally, the compositions of the invention may comprise an inert, or non-reinforcing, filler. Unlike reinforcing fillers, of nanometre size, non-reinforcing fillers are of micrometre size, they are microparticles. For example, these inert fillers may be selected from platy or non-platy fillers such as chalk, graphite, glass flakes or platy fillers based on silicon such as smectites, kaolin, talc, mica, montmorillonites and vermiculite, or a mixture of the latter.

The aforementioned inert fillers are indeed particularly advantageous since they make it possible to improve the impermeability of the compositions in which they are dispersed with a suitable content. For example, when they are used, their total content may vary from 2 phr to 35 phr, preferably from 3 to 25 phr, and in particular from 5 to 20 phr.

The term “graphite” is understood generally to mean an assembly of non-compact hexagonal sheets of carbon atoms: graphenes. Graphite, a hexagonal crystalline system, has a stack of ABAB type where the plane B is translated with respect to the plane A.

Graphite cannot be considered to be a reinforcing filler within the meaning of definition specified in section II-2, however it can be considered to be a semi-reinforcing filler in so far as it permits an increase in the tensile modulus of a rubber composition into which it is incorporated.

When it is used, graphite is present in the composition at contents varying from 2 phr to 35 phr, preferably from 3 to 25 phr and in particular from 5 to 20 phr.

The expression “glass flakes” is understood to mean a synthetic material in the form of platelets composed predominantly of silica (SiO₂), and the composition of which may comprise, inter alia and in addition: K₂O, B₂O₃, ZnO, Na₂O, MgO, CaO, Al₂O₃ and TiO₂. Glass flakes exist with various characteristics depending on the envisaged applications, for example for high chemical resistances or fracture resistances.

The glass flakes are in the form of individual sheets, for which there are a broad range of dimensional parameters. By virtue of their manufacturing process, the glass flakes may have controlled dimensional parameters, and in particular thickness, unlike graphite and other platy fillers. The particle size distribution of the glass flakes is generally broad since the particles have an irregular shape.

The compositions according to the invention use a content of glass flakes that varies from 2 phr to 35 phr, preferably from 3 to 25 phr and in particular from 5 to 20 phr.

In particular, among the platy mineral fillers based on silicon, phyllosilicates and particularly those included in the group consisting of smectites, kaolin, talc, mica and vermiculite are suitable. For example, when they are used, their content may vary from 2 phr to 35 phr, preferably from 3 to 25 phr, and in particular from 5 to 20 phr.

### I-4 Plasticizer

For the implementation of the invention, it is optionally possible to use a plasticizer which is, for example, selected from hydrocarbon-based resins, the glass transition temperature of which is above 20° C. and the softening point of which is below 170° C., or from polyisobutylene oils having a number-average molecular weight (Mn) between 200 g/mol and 40 000 g/mol, or from mixtures of these oils and/or resins.

In total, the content of plasticizer varies from 2 to 50 phr, preferably from 5 to 25 phr.

### I-4-A Thermoplastic Resin

The rubber compositions of the invention may use a hydrocarbon-based plasticizing resin, the Tg, glass transition temperature, of which is above 20° C. and the softening point of which is below 170° C., as explained in detail below.

In a manner known to a person skilled in the art, the designation “plasticizing resin” is reserved in the present application, by definition, for a compound which is, on the one hand, solid at ambient temperature (23° C.) (as opposed to a liquid plasticizing compound such as an oil) and, on the other hand, compatible (i.e., miscible at a content used, typically greater than 5 phr) with the rubber composition for which it is intended, so as to act as a true diluent.

Hydrocarbon-based resins are polymers well known to a person skilled in the art, miscible therefore by nature in the compositions of elastomer(s) when they are also described as “plasticizing”.

They have been widely described in the patents or patent applications cited in the introduction of the present document, and also for example in the work entitled “Hydrocarbon Resins” by R. Mildenberg, M. Zander and G. Collin (New York, VCH, 1997, ISBN 3-527-28617-9), chapter 5 of which is devoted to their applications, especially in rubber tyres (5.5. “Rubber Tires and Mechanical Goods”).

They may be aliphatic (for example of C₅-cut or C₉-cut), naphthenic, aromatic or else of aliphatic/naphthenic/aromatic type, i.e., based on aliphatic and/or naphthenic and/or aromatic monomers. They may be natural or synthetic, whether or not based on petroleum (if such is the case, they are also known as petroleum resins). They are preferably exclusively hydrocarbon-based, that is to say that they comprise only carbon and hydrogen atoms.

As is known, a C₅-cut (or, for example, respectively C₉-cut) is understood to mean any fraction resulting from a process resulting from the petrochemistry or refining of oils, any distillation cut predominantly containing compounds having 5 (respectively 9 in the case of a C₉₋cut) carbon atoms.

Preferably, the hydrocarbon-based plasticizing resin has at least one, more preferably all, of the following features:

a number-average molecular weight (Mn) between 400 and 2000 g/mol;

a polydispersity index (Ip) of less than 3 (reminder: Ip=Mw/Mn with Mw the weight-average molecular weight).

The glass transition temperature Tg is measured in a known manner by DSC (differential scanning calorimetry), according to the standard ASTM D3418 (1999), and the softening point is measured according to the standard ASTM E-28.

The macrostructure (Mw, Mn and Ip) of the hydrocarbon-based resin is determined by size exclusion chromatography (SEC): tetrahydrofuran solvent; 35° C. temperature; 1 g/l concentration; 1 ml/min flow rate; solution filtered through a filter with a porosity of 0.45 μm before injection; Moore calibration using polystyrene standards; set of three Waters columns in series (“Styragel” HR4E, HR1 and HR0.5); differential refractometer (Waters 2410) detection and its associated operating software (Waters Empower).

According to one particularly preferred embodiment, the hydrocarbon-based plasticizing resin is selected from the group consisting of cyclopentadiene (abbreviated to CPD) or dicyclopentadiene (abbreviated to DCPD) homopolymer or copolymer resins, terpene homopolymer or copolymer resins, C₅-cut homopolymer or copolymer resins, and mixtures of these resins; and more preferably still, the resin is a C₅-cut homopolymer or copolymer resin or a mixture of the latter.

When it is used, the content of hydrocarbon-based resin is preferably between 2 and 35 phr. Below the minimum indicated, the targeted technical effect may prove insufficient, whereas above the maximum, the tack of the compositions in the uncured state, with respect to the compounding tools, may in certain cases become unacceptable from an industrial viewpoint. The content of hydrocarbon-based resin is more preferably still between 5 and 25 phr.

### I-4-B Polyisobutylene Oil

The rubber compositions of the invention may use an extender oil (or plasticizing oil), the customary role of which is to facilitate the processing, via a lowering of the Mooney plasticity and to improve the endurance via a reduction of the elongation moduli in the cured state.

At ambient temperature (23° C.), these oils, which are more or less viscous, are liquids (that is to say, to recapitulate, substances having the ability to eventually assume the shape of their container), in contrast in particular to resins or rubbers, which are solids by nature.

Use is made, in accordance with the invention, of polyisobutylene oils having a number-average molecular weight (Mn) between 200 g/mol and 40 000 g/mol. For excessively low weights Mn, there is a risk of migration of the oil to outside of the composition, whereas excessively high weights may lead to excessive stiffening of this composition. The aforementioned polyisobutylene oils of low molecular weight have demonstrated a much better compromise of properties compared to the other oils tested, in particular conventional oils of paraffin type.

By way of examples, polyisobutylene oils are sold in particular by Univar under the name “Dynapak Poly” (e.g., “Dynapak Poly 190”), by BASF under the names “Glissopal” (e.g., “Glissopal 1000”) or “Oppanol” (e.g., “Oppanol B12”), by Texas Petrochemicals under the name “TPC” (“TPC 1350”) and by Innovene under the name “INDOPOL”.

The number-average molecular weight (Mn) of the polyisobutylene oil is determined by SEC, the sample being dissolved beforehand in tetrahydrofuran at a concentration of approximately 1 g/l; the solution is then filtered through a filter with a porosity of 0.45 μm before injection. The equipment is the “Waters Alliance” chromatographic line. The elution solvent is tetrahydrofuran, the flow rate is 1 ml/min, the temperature of the system is 35° C. and the analysis time is 30 min. Use is made of a set of two “Waters” columns bearing the name “Styragel HT6E”. The injected volume of the solution of the polymer sample is 100 μA. The detector is a “Waters 2410” differential refractometer and its associated software for handling the chromatographic data is the “Waters Millenium” system. The calculated average molecular weights are relative to a calibration curve produced with polystyrene standards.

The polyisobutylene oils of low molecular weight suitable for the invention may or may not be functionalized. Thus, mention may be made, by way of non-limiting example, of certain functionalizations of polyisobutylene oils such as polyisobutylene succinic anhydride (PIBSA) oils or polyisobutylene succinimide (PIBSI) oils.

When it is used, the content of polyisobutylene oil is preferably between 2 and 35 phr. Below the minimum indicated, the elastomer layer or composition risks having an excessively high stiffness for certain applications whereas above the recommended maximum there is a risk of insufficient cohesion of the composition and of loss of airtightness which may be harmful depending on the application in question.

The content of polyisobutylene oil is more preferably still between 5 and 25 phr.

### I-5 Crosslinking System

The expression “crosslinking system” is understood to mean the chemical agent (or chemical agents) introduced during the phase referred to as the “productive” phase of the preparation of the compositions (see paragraph on the preparation of the compositions). This chemical agent enables the elastomer chains to bond together with one another forming a 3-dimensional network, this is the crosslinking phenomenon.

Customarily, for the crosslinking of the compositions of airtightness layers, in particular of pneumatic objects, sulphur or a sulphur donor is used. The sulphur is customarily added at a preferred content of between 0.5 and 12 phr, in particular between 1 and 10 phr. In the pneumatic objects of the invention, the crosslinking system for the airtightness layer has a sulphur content of less than 0.5 phr or even of zero. A quantity of sulphur, not part of the crosslinking system, is potentially present in the compositions of the invention. This sulphur may originate from the other ingredients of the composition, introduced in the phase referred to as the “non-productive” phase of the preparation (see below, the paragraph on the preparation of the compositions). For example, it may originate from the carbon black or from the coupling agent as described above. In the compositions of the invention, the content of sulphur in the composition is less than 2 phr, preferably less than 1.5 phr in the central domain of the airtight layer.

The absence of sulphur or the content thereof of less than 0.5 phr and more particularly less than 0.1 phr in the crosslinking system of the airtightness layers of the invention makes it possible to increase the setting time (or scorch time) of the composition, thus reducing the scorching phenomenon. Furthermore, it has been shown that, surprisingly, the rubbery layer thus crosslinked has a good adhesion to an adjacent sulphur-vulcanized layer.

The crosslinking system of use for the implementation of the invention is based on a metal oxide, it is furthermore free of sulphur or contains a content thereof of less than 0.5 phr. Preferably, the content of sulphur in the crosslinking system is less than 0.3 phr, more preferably less than 0.1 phr and very preferably the crosslinking system is free of sulphur. Preferably, this crosslinking system is free of any standard crosslinking agent other than a metal oxide (such as sulphur or peroxides), or contains less than 0.5 phr (preferably less than 0.3 phr, more preferably less than 0.1 phr) thereof.

Preferably, the metal oxide comprises a metal from group II, IV, V, VI, VII or VIII and oxygen. For example, the metal oxide may be selected from: FeO, Fe₂O₃, Fe₃O₄, CoO, Co₂O₃, NiO, PbO, Pb₃O₄, PbO₂, Sb₂O₃, Sb₂O₅, V₂O₅, CrO₂, MoO₂, WO₂, BeO, MgO, MnO, ZnO, CaO, GeO, TiO, TiO₂, Ti₂O₃, Ti₃O₅, SnO, SnO₂, SrO and BaO. Preferably, the metal oxide is selected from: Fe₂O₃, MgO, ZnO, PbO and TiO₂, and very preferably the metal oxide is ZnO.

The content of metal oxide in the crosslinking system (in other words, the metal oxide content of the crosslinking system in the composition) is preferably within a range varying from 2 to 25 phr, preferably from 2 to 20 phr. Preferably, the content of metal oxide is within a range varying from 3 to 15 phr for a metal oxide having a BET specific surface area (measured according to the standard ISO 4652) of around 4.5 m²/g. For more reactive metal oxides such as those having a BET specific surface area >4.5 m²/g (for example 9.5 m²/g or 45 m²/g), it is possible to drop down to a content of 2 phr, while obtaining equivalent properties. Conversely, for a metal oxide, and in particular for zinc oxide, having a lower specific surface area, this content could be increased.

It is possible to add one or more crosslinking accelerators and/or crosslinking activators. The crosslinking accelerator is used at a preferred content of between 0.2 and 10 phr, more preferably between 0.3 and 6.0 phr. Among these compounds, mention is made of fatty acids such as stearic acid, or guanidine derivatives (in particular diphenylguanidine). It is also possible to use accelerators of thiazole type and also derivatives thereof, and accelerators of thiuram, carbamate and sulphenamide types. These accelerators are for example selected from the group consisting of 2-mercaptobenzothiazyl disulphide (abbreviated to “MBTS”), tetrabenzyl thiuram disulphide (TBzTD), N-cyclohexyl-2-benzothiazyl sulphenamide (CBS), N,N-dicyclohexyl-2-benzothiazyl sulphenamide (DCBS), N-tert-butyl-2-benzothiazyl sulphenamide (TBBS), N-tert-butyl-2-benzothiazyl sulphenimide (TBSI), zinc dibenzyldithiocarbamate (ZBEC) and the mixtures of these compounds. Of course, in the case where the accelerators used are a source of sulphur (for example MTBS or TBzTD), their content is adapted so that the total content of sulphur does not exceed 0.5 phr. Preferably, the airtightness layer according to the invention may contain an accelerator with the exception of those which are also sulphur donors. More preferably, the airtightness layer according to the invention contains no accelerator. In other words, in the absence of activator and/or accelerator, the crosslinking system may consist solely of metal oxide.

### I-6 Various Additives

The rubber compositions in accordance with the invention may also comprise all or some of the standard additives customarily used in the elastomer compositions intended for the manufacture of tyres, in particular of airtightness layers, such as for example protective agents such as antiozone waxes, chemical antiozonants, antioxidants, anti-fatigue agents, reinforcing resins, methylene acceptors (for example phenolic-novolac resin) or methylene donors (for example HMT or H3M) as described, for example, in Application WO 02/10269.

These compositions may also contain, in addition to coupling agents, coupling activators, agents for covering the reinforcing inorganic filler or more generally processing aids capable, in a known manner, by virtue of an improvement in the dispersion of the inorganic filler in the rubber matrix and of a lowering of the viscosity of the compositions, of improving their processability in the uncured state, these agents being, for example, hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxy-polyorganosiloxanes (in particular α,ω-dihydroxy-polydimethylsiloxanes), and fatty acids such as for example stearic acid.

### II—PREPARATION OF THE COMPOSITIONS

The compositions are manufactured in appropriate mixers, using two successive preparation phases well known to a person skilled in the art: a first phase of thermomechanical working or kneading at high temperature, up to a maximum temperature of between 110° C. and 190° C., preferably between 115° C. and 150° C. and more preferably still between 115° C. and 140° C. (especially when the composition is based on a halogenated butyl elastomer) followed by a second phase of mechanical working up to a lower temperature, typically below 110° C., for example between 40° C. and 100° C., during which finishing phase the crosslinking system is incorporated.

The process for preparing a rubber composition for a layer airtight to inflation gases comprises the following stages:

incorporating into a halogenated elastomer, during a first stage, at least one reinforcing filler, by thermomechanically kneading everything, in one or more steps, until a maximum temperature of between 110° C. and 190° C. is reached; (this preparation phase is referred to as a “non-productive” phase);

subsequently incorporating, during a second stage, the crosslinking system and kneading everything up to a maximum temperature below 110° C. (this preparation phase is referred to as a “productive” phase).

These two stages may be carried out consecutively in one and the same mixer or be separated by a stage of cooling to a temperature below 100° C., the last stage then being carried out in a second mixer.

By way of example, the first phase is carried out in a single thermomechanical stage during which, in a first step, all the necessary base constituents (halogenated elastomer and reinforcing filler) are introduced into an appropriate mixer such as a standard internal mixer, followed, in a second step, for example after kneading for one to two minutes, by the other additives, optional additional filler-covering agents or processing aids, with the exception of the crosslinking system. After cooling the mixture thus obtained, the crosslinking system is then incorporated in an external mixer, such as an open mill, maintained at low temperature (for example between 40° C. and 100° C.). The whole mixture is then mixed for a few minutes, for example between 2 and 15 min.

It will be noted that, in particular, when the predominant elastomer is selected from the halogenated butyl rubbers, the incorporation of the crosslinking system may take place in the same mixer as in the first phase of thermomechanical working

The final composition thus obtained is then calendered, for example in the form of a sheet or a slab, in particular for laboratory characterization, or else extruded in the form of a rubber profiled element that can be used as an airtightness layer of a tyre. During this extrusion step, the setting time of the compositions according to the invention is such that they withstand working at higher temperature, which makes it possible to increase the speed of the extruder and thus to improve the productivity of this extrusion.

The crosslinking (or curing) is carried out at a temperature generally between 130° C. and 200° C., for a sufficient time which may vary, for example, between 5 and 90 min as a function, in particular, of the curing temperature, of the vulcanization system used and of the crosslinking kinetics of the composition in question.

The invention relates to the rubber layers described previously both in the “uncured” state (i.e., before curing) and in the “cured” or vulcanized state (i.e., after vulcanization).

The invention also relates to the preparation process as described above. The invention preferably relates to a process as defined above, in which, between the thermomechanical kneading and the incorporation of the crosslinking system, the whole mixture is cooled to a temperature of less than or equal to 100° C.

### III—EXAMPLES

### III-1 Characterization of the Rubber Compositions

### III-1-a Scorch Time (or Setting Time)

The measurements are carried out at 130° C., in accordance with the French standard NF T 43-005. The change in the consistency index as a function of the time makes it possible to determine the scorch time of the rubber compositions, assessed in accordance with the aforementioned standard by the parameter T5 (case of a large rotor), expressed in minutes, and defined as being the time needed to obtain an increase in the consistency index (expressed in MU) of 5 units above the minimum value measured for this index.

### III-1-b Crosslinking Characteristics: Rheometry

The measurements are carried out at 150° C. with an oscillating chamber rheometer, according to the standard DIN 53529—part 3 (June 1983). The change in the rheometric torque as a function of the time describes the change in the stiffening of the composition following the crosslinking reaction. The measurements are processed according to the standard DIN 53529—part 2 (March 1983):
ti is the induction time, that is to say the time needed for the onset of the crosslinking reaction;
t_{α} (for example t₉₀,) is the time needed to reach a conversion of α %, that is to say α % (for example 90%) of the difference between the minimum and maximum torques.

### III-1-c Mooney Viscosity (or Mooney Plasticity)

Use is made of an oscillating consistometer as described in the French standard NF T 43-005 (1991). The Mooney plasticity is measured according to the following principle: the composition in the uncured state (i.e., before curing) is moulded in a cylindrical chamber heated to 100° C. After preheating for one minute, the rotor rotates within the test specimen at 2 rpm and the working torque for maintaining this movement is measured after rotating for 4 minutes. The Mooney plasticity (ML 1+4) is expressed in “Mooney units” (MU, with 1 MU=0.83 Newton·metre).

### III-1-d Airtightness Tests

The permeability values are measured using a MOCON OXTRAN 2/60 permeability “tester” at 40° C. Cured test specimens in the form of discs having a given thickness (approximately 0.8 to 1 mm) are mounted on the apparatus and sealed with vacuum grease. One of the faces of the disc is maintained under 10 psi of nitrogen while the other face is maintained under 10 psi of oxygen. The increase in oxygen concentration is monitored using a “Coulox” oxygen detector on the face maintained under nitrogen. The oxygen concentration on the face maintained under nitrogen for achieving a constant value, used to determine the oxygen permeability, is recorded.

An arbitrary value of 100 is given for the oxygen permeability of the control, a result of less than 100 indicating a reduction in the oxygen permeability and therefore better impermeability.

### III-1-e Tensile Tests

These tests make it possible to determine the elasticity stresses and the properties at break. Unless otherwise indicated, they are carried out in accordance with the French standard NF T 46-002 of September 1988. At second elongation (i.e., after an accommodation cycle) the “nominal” secant moduli (or apparent stresses, in MPa) are measured at 10% elongation (denoted by “MA10”) and 100% elongation (“MA100”). All these tensile measurements are carried out under standard temperature (23° C.±2° C.) and hygrometry (50%±5% relative humidity) conditions, according to the French standard NF T 40-101 (December 1979). The stresses at break (in MPa) and the elongations at break (in %) are also measured, at a temperature of 23° C.

For greater clarity, the results will be indicated relative to a base 100, the value 100 being attributed to the control. A result of less than 100 will indicate a reduction of the value in question, and conversely, a result of greater than 100 will indicate an increase of the value in question.

### III-2 Characterization of the Tyres

### III-2-a Peel Test

The peel test describes the adhesion between two layers of rubber within a tyre, for example between the inner airtightness layer and the carcass ply. The interface is initiated, then separated at an angle of 180° and at a temperature of 23° C. The force for separating the two interfaces is recorded and the value is expressed in newtons. The tyre cover is prepared in three stages: removal of the bead wire, locating of the interface studied, and start of separation of this interface.

In the case of highly deformable elastomers and of strong adhesion between the two layers, the test may result in failure of the material before it is separated from the adjacent layer. This result indicates a good adhesion between the two layers since they cannot be separated. This result is denoted by “failure” in the tests presented below.

III-2-a Test of Pressure Loss after 4 Weeks

Measurement tests were carried out in order to evaluate the pressure loss of tyres after four weeks at 20° C.

The airtightness of the tyres was measured by measuring the pressure loss at 20° C. after 4 weeks. The results presented below are presented relative to a base 100: an arbitrary value of 100 is given for the airtightness performance of the control, a result of greater than 100 indicating a better airtightness performance, therefore a reduction in the pressure loss after 4 weeks.

### III-2 Examples of Compositions

The examples presented below are prepared as indicated above, their composition is given in Table 1, in phr.

TABLE 1

| | C1 | C2 | C3 | C4 | C5 | C6 | C7 | C8 | C9 | C10 | C11 | C12 |
|---|---|---|---|---|---|---|---|---|---|---|---|---|
| Bromobutyl (1) | 100 | 100 | 100 | 100 | 100 | 100 | 100 | 100 | 100 | 100 | 100 | 100 |
| N772 | 50 | 50 | 50 | 50 | 50 | 50 | 50 | 50 | 50 | 50 | 50 | 50 |
| Graphite (2) | — | 10 | — | 10 | 10 | 10 | 10 | 10 | 10 | 10 | 10 | 10 |
| Kaolin (3) | 10 | — | 10 | — | — | — | — | — | — | — | — | — |
| Resin (4) | 5 | 7 | 5 | 7 | 7 | 7 | 7 | 7 | 7 | 7 | 7 | 7 |
| ZnO 4.5 m²/g | 1.5 | 1.5 | 6 | 6 | 4 | 8 | 10 | 15 | — | — | 6 | 6 |
| ZnO 9.5 m²/g | — | — | — | — | — | — | — | — | 4 | — | — | — |
| ZnO 45 m²/g | — | — | — | — | — | — | — | — | — | 4 | — | — |
| Sulphur | 1.5 | 1.5 | — | — | — | — | — | — | — | — | — | — |
| MBTS | 1.2 | 1.2 | — | — | — | — | — | — | — | — | — | 1 |
| Stearic acid | 1.5 | 1.5 | 0.5 | 0.5 | 0.5 | 0.5 | 0.5 | 0.5 | 0.5 | 0.5 | — | 0.5 |

(1) “BROMOBUTYL 2222” brominated polyisobutylene sold by EXXON CHEMICAL Co.
(2) “TIMREX 80 × 150” natural graphite sold by TIMCAL.
(3) “Kerbrient SP20” natural kaolin from Imerys.
(4) “Hikorez A-1100” aliphatic resin (pure C₅), (Tg = 49° C., softening point 99° C.), sold by KOLON.

Compositions C1 and C2 are control compositions, they comprise sulphur as vulcanization agent, composition C1 is the control for composition C3 and composition C2 is the control for compositions C4 to C12. Compositions C3 to C12, in accordance with the invention, are compositions that comprise only metal oxide as a crosslinking agent. They vary from one another by the nature of the inert filler, the content of metal oxide, the nature of the metal oxide, the presence or absence of an accelerator such as MTBS and the presence or absence of a fatty acid such as stearic acid.

### III-3 Properties of the Compositions

III-3-a. Properties in the Uncured State and Cured Properties

The properties in the uncured state and the cured properties of the compositions presented above are presented in Table 2 below.

TABLE 2

| | C1 | C2 | C3 | C4 | C5 | C6 | C7 | C8 | C9 | C10 | C11 | C12 |
|---|---|---|---|---|---|---|---|---|---|---|---|---|
| T5 (min) | 13.2 | 16.7 | 23.1 | 26.5 | 29.1 | 27.0 | 23.8 | 28.9 | 26.7 | 25.0 | 30.6 | 17.6 |
| ti at 150° C. (min) | 1.7 | 7.5 | 7.9 | 8.5 | 8.7 | 8.6 | 8.9 | 9.1 | 8.1 | 8.6 | 10.7 | 5.0 |
| t90 at 150° C. (min) | 25.2 | 24.5 | 25.3 | 28.3 | 30.0 | 29.4 | 30.2 | 31.3 | 29.2 | 35.2 | 34.5 | 15.4 |
| ML(1 + 4) 100° C. (MU) | 65 | 65 | 68 | 65 | 64 | 65 | 65 | 65 | 65 | 66 | 65 | 64 |

The comparison of compositions C1 and C3 shows the significant increase of the T5 and ti values in composition C3 in accordance with the invention relative to the control composition C1, the crosslinking agent of which is sulphur. It is furthermore noted that the t90 rheometry properties are maintained and that the Mooney plasticity is maintained, indicating that the processing properties are identical. With a different inert filler, the same observations can be made between C2 and C4.

The variation of the content of metal oxide in compositions C4 to C8 shows that satisfactory Mooney viscosity and t90 values are maintained with a metal oxide content varying from 4 to 15 phr. The change in the specific surface area of the zinc oxide, used in compositions

C5, C9 and C10, also results in maintained properties with satisfactory Mooney viscosity and t90 values.

The T5 values and t1 and t90 values at 150° C. are increased still further in composition C11 relative to the control composition C2. The Mooney viscosity is maintained.

In composition C12, an accelerator is added to the metal oxide for the crosslinking It is observed that this addition leads to a T5 value that is still increased relative to composition C2 and a ti value at 150° C. that is lower. The advantage of adding an accelerator to the composition therefore becomes limited as regards the increase in the setting time of the compositions. On the other hand, this addition makes it possible to adjust the effect of the change of crosslinking system. This adjustment may prove industrially useful. Furthermore, the addition of accelerator is not detrimental to the Mooney viscosity.

III-3-a. Properties in the Cured State

The properties after curing of the compositions presented above are presented in Tables 3a and 3b below.

TABLE 3a

| | C1 | C3 |
|---|---|---|
| Permeability relative to base 100 | 100 | 92 |
| MA100 relative to base 100 | 100 | 87 |
| Tensile strength relative to base 100 | 100 | 92 |
| Elongation at break relative to base 100 | 100 | 100 |

By comparing compositions C1 and C3 in the cured state, a decrease in the permeability is noted, which indicates a better impermeability of the airtightness layers according to the invention. A slight drop in MA100, and in the tensile strength is also noted, the elongation at break remaining identical. These properties are good for an airtightness layer.

TABLE 3b

| | C2 | C4 | C5 | C6 | C9 | C10 |
|---|---|---|---|---|---|---|
| Permeability relative to base 100 | 100 | 96 | 91 | 100 | 96 | 99 |
| MA100 relative to base 100 | 100 | 93 | 94 | 93 | 91 | 93 |
| Tensile strength relative to base 100 | 100 | 89 | 93 | 89 | 89 | 88 |
| Elongation at break relative to base 100 | 100 | 91 | 94 | 94 | 89 | 90 |

The comparison of the control C2 with compositions C4, C5, and C9 makes it possible to note a decrease in the permeability, which indicates a better impermeability of the airtightness layers according to the invention. Compositions C6 and C10 have the same level of airtightness as the control. Furthermore, the mechanical properties, which are the MA100, the tensile strength and the elongation at break, of the compositions according to the invention are slightly lower than those of the control, these properties nevertheless remain acceptable for the airtightness layers of the invention.

### III. 4 Tyre Tests

Tyres (denoted by “tyre A”) were manufactured, the airtightness inner layer of which is in accordance with composition C4 presented above. The properties of these tyres are compared to those of tyres (denoted by “control tyre”), the airtightness inner layer of which is in accordance with composition C2 presented above.

The properties of the compositions presented above are presented in Table 4 below.

TABLE 4

| | Control tyre | Tyre A |
|---|---|---|
| Peel | rupture | rupture |
| Pressure loss relative to base 100 | 100 | 104 |

These tests show that the tyres provided with an airtightness layer according to the invention have improved airtightness properties and adhesion properties (peel test) that are as good as those of tyres provided with a sulphur-vulcanized airtightness layer. These results are unexpected, and in particular the good adhesion of the airtightness layer with the adjacent layer (for example the carcass ply). This is because these two layers are crosslinked differently and have, in the example, very different elastomeric compositions, based on a halogenated butyl for the airtightness layer and based on diene elastomer for the carcass ply.

1-18. (canceled)

19: A layer airtight to inflation gases, the layer comprising a composition based on at least:
a halogenated elastomer having a content of greater than or equal to 70 parts by weight per hundred parts by weight of elastomer (phr);
a reinforcing filler; and
a crosslinking system based on a metal oxide, wherein the crosslinking system is free of sulphur or contains less than 0.1 phr of sulphur.

20: The layer according to claim 19, wherein the halogenated elastomer is selected from a group of halogenated butyl rubbers, and wherein the group includes a brominated butyl rubber.

21: The layer according to claim 19, wherein a content of the halogenated elastomer is greater than or equal to 85 phr.

22: The layer according to claim 19, wherein a content of the halogenated elastomer is 100 phr.

23: The layer according to claim 19, wherein the metal oxide is selected from a group that includes: metal oxides of metals of Groups II, IV, V, VI, VII, and VIII; and mixtures of the metal oxides.

24: The layer according to claim 23, wherein the metal oxide is zinc oxide.

25: The layer according to claim 19, wherein a content of the metal oxide is within a range varying from 2 to 25 phr.

26: The layer according to claim 19, wherein the reinforcing filler is carbon black or silica, or is a combination of carbon black and silica.

27: The layer according to claim 19, wherein a content of the reinforcing filler is within a range varying from 30 to 90 phr.

28: The layer according to claim 19, wherein a content of the reinforcing filler is within a range varying from 35 to 70 phr.

29: The layer according to claim 19, wherein the composition further includes an inert filler.

30: The layer according to claim 29,
wherein the inert filler is selected from a group that includes: chalk; graphite; glass flakes; and silicon-based platy fillers, and
wherein the platy fillers include one or any mixture of: smectites, kaolin, talc, mica, montmorillonites, and vermiculite.

31: The layer according to claim 29, wherein a content of the inert filler is within a range varying from 2 to 35 phr.

32: The layer according to claim 19, wherein the composition further includes a plasticizer.

33: The layer according to claim 32, wherein the plasticizer is selected from a group that includes: hydrocarbon-based resins having a glass transition temperature above 20° C. and a softening point below 170° C.; polyisobutylene oils having a number-average molecular weight (Mn) between 200 g/mol and 40 000 g/mol; and mixtures thereof.

34: The layer according to claim 32, wherein a content of the plasticizer is within a range varying from 2 to 50 phr.

35: The layer according to claim 32, wherein a content of the plasticizer is within a range varying from 5 to 25 phr.

36: The layer according to claim 19, wherein the crosslinking system is free of sulphur.

37: A pneumatic object comprising a layer airtight to inflation gases, wherein the layer is formed of a composition based on at least:
a halogenated elastomer having a content of greater than or equal to 70 parts by weight per hundred parts by weight of elastomer (phr);
a reinforcing filler; and
a crosslinking system based on a metal oxide, wherein the crosslinking system is free of sulphur or contains less than 0.1 phr of sulphur.

38: A tyre comprising a layer airtight to inflation gases, wherein the layer is formed of a composition based on at least:
a halogenated elastomer having a content of greater than or equal to 70 parts by weight per hundred parts by weight of elastomer (phr);
a reinforcing filler; and
a crosslinking system based on a metal oxide, wherein the crosslinking system is free of sulphur or contains less than 0.1 phr of sulphur.
